(19) United States
(12) Patent Application Publication
(10) Pub. No.: US 2009/0040679 A1
(43) Pub. Date: Feb. 12, 2009

(54) Method and device for recognizing a load which is connected to a relay

(75) Inventor: Harald Lauter, Bad Waldsee/Kummerazhofen (DE)

Correspondence Address: CONTINENTAL TEVES, INC., ONE CONTINENTAL DRIVE, AUBURN HILLLS, MI, 48326-1581, US

(73) Assignee: Conti Temic Microelectronic GMBH

(21) Appl. No.: 11/918,530

(22) PCT Filed: Feb. 18, 2006
(86) PCT No.: PCT/DE2006/000304

§ 371 Date: Oct. 15, 2007

(30) Foreign Application Priority Data
Apr. 14, 2005 (DE) 10 2005 017 135.4

(51) Int. Cl. H01H 47/00

(52) U.S. Cl. 361/139

(57) ABSTRACT

Disclosed is a method for detecting a consumer (4) connected to a change-over contact (3, 3A, 3B) of a relay (2, 2A, 2B), whereby in a contactless time period while the relay (2, 2A, 2B) is being connected, a test voltage is used to check whether the consumer (4) is connected. For this purpose, a check is made while the relay (2, 2A, 2B) is being connected as to whether at least part of the test voltage drops in the circuit of the consumer (4).

### BACKGROUND OF THE INVENTION

The invention relates to a method and a device for detecting a consumer which is connected to a change-over contact of a relay.

For diagnostics purposes, it is necessary to detect electrically whether a consumer is connected to a relay or relay bridge. A detection of this type can in particular be used prior to mechanical sequences in which several actuators are involved as consumers, for example in the form of electric motors. If it is detected prior to such a sequence that an actuator is not connected, the entire procedure is blocked.

For example, it is not necessary to begin a movement sequence for automatically opening a cover of a cabriolet if it can already be detected prior to the beginning of the movement sequence that window winder motors or a locking claw which are required for the automatic opening of the roof are not ready for use.

According to the prior art, a measuring resistance is connected in series with the consumer as a shunt in order to detect a consumer connected to a relay. Via a drop in voltage on the measuring resistance, a flowing load current can be determined by means of an evaluation circuit, which indicates the presence of a connected load. The evaluation is generally conducted using a microcontroller.

This procedure is complex due to the required measuring resistance and evaluation circuit. Using current measurement, the presence of a motor can only be checked when the relay has already been switched on for several milliseconds. However, then, the point in time at which the motor can be detected has then disadvantageously already passed. For current measurement, a free analogue input to a microcontroller is also required. Analogue inputs cannot be interconnected without additional time and effort. With two motor output stages, two analogue inputs are thus required, for example.

The object of the invention is therefore to provide an improved method and an improved device of the type described in the introduction, with which the disadvantages described above are avoided.

### SUMMARY OF THE INVENTION

According to the invention, the object is attained by a method for detecting a relay (2, 2A, 2B) of a consumer (4) connected to a change-over contact (3, 3A, 3B), whereby in a contactless time period during a connection of the relay (2, 2A, 2B), a test is conducted by means of a test voltage as to whether the consumer (4) is connected. The object is also achieved by a device for detecting a consumer (4) connected to a change-over contact (3, 3A, 3B) of a relay (2, 2A, 2B), whereby a voltage source for a test voltage and a resistance (6, 6A, 6B) are connected in series with the consumer (4), and a test device (8) for identifying a voltage drop in the circuit of the consumer (4) is connected with the resistance (6, 6A, 6B.

In the method according to the invention, in a contactless time period while the relay is being connected, an identification is made by means of a test voltage in a circuit of the consumer as to whether a consumer is connected. For this purpose, a test is preferably conducted as to whether at least one part of the test voltage drops in the circuit of the consumer. With a circuit which is closed by the consumer, a drop in voltage can be determined, but not in other cases. This makes it possible to detect the consumer with little time and effort. No flowing load current is required. Already at the end of the relay connection procedure, it can be determined on the basis of a possible drop in voltage whether a consumer is connected and integrated.

Here, the time behaviour of a voltage pulse is advantageously compared at a point in the circuit of the consumer with definable comparative values, in order to identify the drop in voltage.

In a preferred embodiment, a negative test voltage is used. The test voltage can be generated with little time and effort from an operating voltage of the relay and/or of the consumer.

In the device according to the invention, a voltage source is connected for a test voltage, and a resistance is connected in series with the consumer. A test device for identifying a drop in voltage which occurs in the circuit of the consumer is also connected with the resistance.

Preferably, the voltage source is designed as a capacitor. In an embodiment which can be produced with little time and effort, the test device is designed as a microcontroller.

In a preferred embodiment, the microcontroller is connected with the resistance via a comparator.

Advantageously, the test voltage conforms to an operating voltage of the relay and/or of the consumer.

In a particular embodiment, the relay is designed as the first relay of a relay bridge. Here, the first relay is advantageously provided for a first polarity of the consumer, and a second relay of the relay bridge is provided for a second polarity of the consumer.

A preferred embodiment provides that for the second relay, a second voltage source is connected for a test voltage, and a second resistance is connected in series with the consumer.

More advantageously, the test device is connected with the second resistance in order to identify a drop in voltage which occurs in the circuit of the consumer.

The advantages gained with the invention consist in particular of the fact that due to the identification of a connected consumer at the point in time of the changeover of relay contacts, no flowing load current is required. In this way, a connected consumer can be identified with essentially little time and effort. In particular, the connection of all the consumers involved in a mechanical sequence can be tested in advance in a diagnostics routine.

### BRIEF DESCRIPTION OF THE DRAWINGS

Exemplary embodiments of the invention will now be explained in greater detail with reference to the drawings, in which:

FIG. 1 shows a circuit diagram of a device with a relay, and

FIG. 2 shows a circuit diagram of a device with a relay bridge.

### DETAILED DESCRIPTION THE DRAWINGS

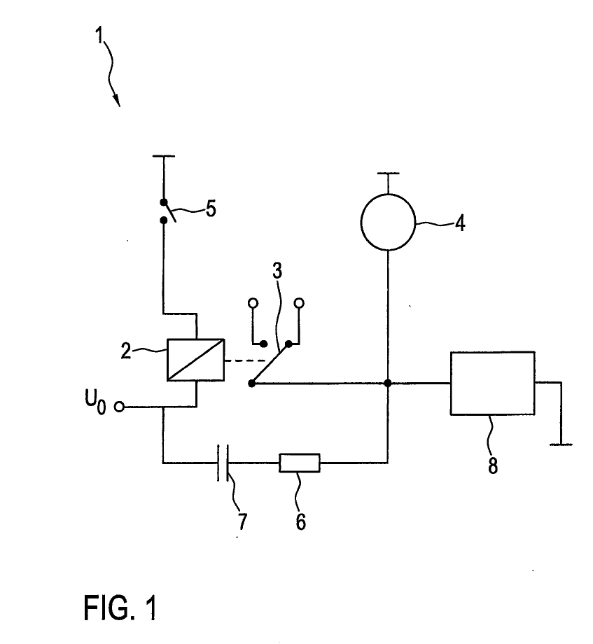

FIG. 1 shows an embodiment of a device 1 with a single relay 2, to the change-over contact 3 of which a consumer 4 is connected. The relay 2 can in this simple case be connected by means of a switch 5. The consumer 4 is connected with the operating voltage U₀ by means of a resistance 6 and a capacitor 7.

Between the consumer 4 and the resistance 6, a test device 8 is connected, which evaluates voltage pulses to the node point between the consumer 4 and the resistance 6.

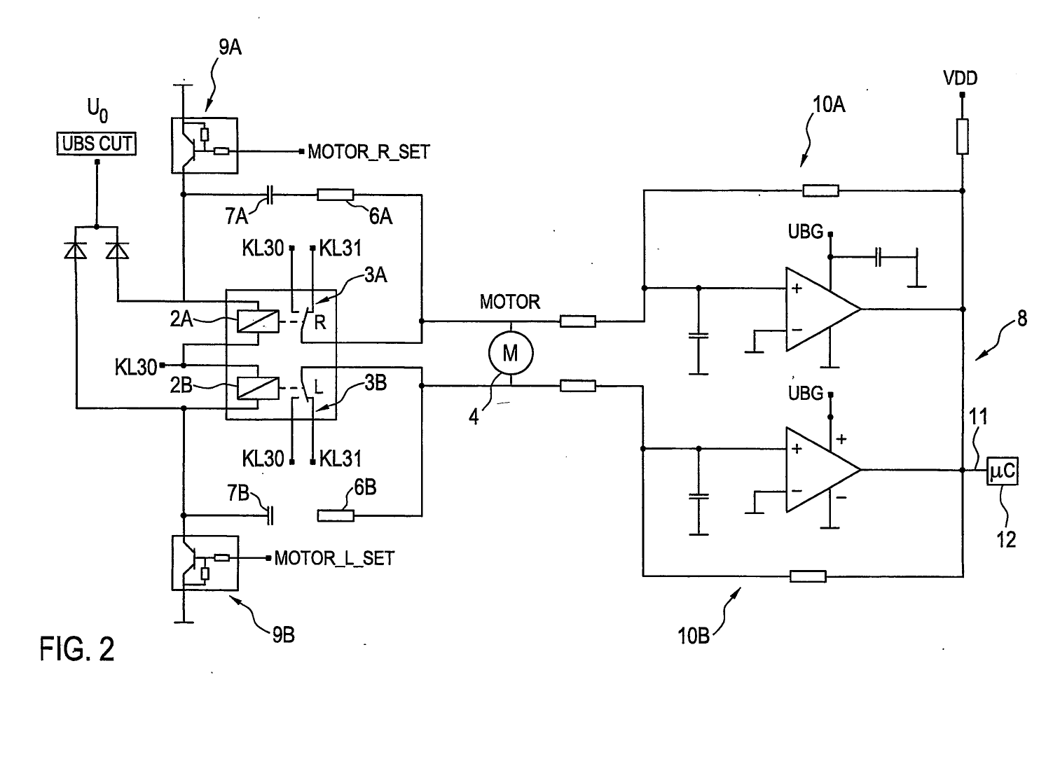

FIG. 2 shows the more complex case of a relay bridge of a window winder. Here, a first relay 2A and a second relay 2B are controlled with the respective change-over contacts 3A and 3B from one connection transistor 9A, 9B each. A consumer 4 which is designed as a window winder motor is connected with the change-over contacts of the relay 2A, 2B. The first relay 2A is provided for a clockwise rotation of the motor, while the second relay 2B is provided for the anti-clockwise rotation.

The consumer 4 is on the one hand connected via a first resistance 6A and a first capacitor 7A, and on the other hand, via a second resistance 6B and a second capacitor 7B to the operating voltage U₀=+12 V, which is applied on the terminals KL30 of the relay 2A, 2B. The resistances 6A, 6B and the capacitors 7A, 7B here correspond in their function with the resistance 6 and the capacitor 7 of the circuit shown in FIG. 1.

The connections of the consumer 4 are connected via separate comparator circuits 10A, 10B with an input 11 of a microcontroller 12 shown in the drawing. The comparator circuits 10A, 10B and the microcontroller 12 are here used as a test device 8.

The mode of functioning of the circuits shown in FIGS. 1 and 2 is based on the application of a test voltage in the circuit of the consumer 4 in a time period in which a relay 2A, 2B is in the process of being changed. Advantageously, a negative test voltage is applied in order to clearly differentiate between the test voltage and a drive voltage for the consumer 4.

When idle, the terminals KL31 of the relays 2A, 2B are at earth. Neither of the relays 2A, 2B are activated. The consumer 4 is connected with earth at both connections. The capacitor 7A, 7B between the consumer 4 and the operating voltage U₀ are charged.

If the first relay 2A is triggered for clockwise rotation with an interrupted load by the related connection transistor 9A, the voltage on the coil of the first relay 2A jumps from U₀ to earth. The charged capacitor 7A cannot immediately discharge itself. It therefore generates a negative voltage of −12 V on the relay side connection of the consumer 4 for a short period of time. At the same time, the first relay 2A is connected for clockwise rotation.

For the duration of the connection procedure, the potential of the change-over contact 3A lies in the air. The connection procedure of the change-over contact 3A lasts approximately 500 μs. During this time, no voltage drops on the resistance 6A. The potential of the change-over contact 3A jumps to −12 V. The comparator circuit 10A identifies a negative voltage pulse for a time of approximately 500 μs, and communicates this to the input 11, e.g. a timer input, of the microcontroller 12. By means of the microcontroller 12, the quality of the pulse, in particular the time behaviour of the voltage pulse, is compared with definable comparative values, and a consumer which is not connected is thus identified as follows.

If a consumer 4 is connected, the voltage on the coil of the first relay 2A jumps from the operating voltage U₀ to earth after the corresponding connection transistor 9A is triggered. In this case also, the charged capacitor 7A cannot immediately discharge itself. It therefore generates for a brief period of time a negative voltage of −12 V on the relay side connection of the consumer 4. At the same time, the first relay 2A is connected for clockwise rotation. For the duration of the connection procedure, the potential of the change-over contact 3A lies above the load of the consumer 4, and the second relay 2B lies at low resistance at earth. The negative voltage of the capacitor 7A drops on the resistance 6A. The comparator circuit 10A identifies no negative voltage, and is not connected. By means of the microcontroller 12, a connected consumer 4 is identified in this case.

### LIST OF REFERENCE NUMERALS

1 Device
2 Relay
2A First relay
2B Second relay
3, 3A, 3B Change-over contact
4 Consumer
5 Switch
6 Resistance
6A First resistance
6B Second resistance
7 Capacitor
7A First capacitor
7B Second capacitor
8 Test device
9, 9A, 9B Connection transistor
10A, 10B Comparator circuit
11 Timer input
KL30 Terminal
KL31 Terminal
U₀ Operating voltage

1-14. (canceled)

15. A method for detecting a relay (2, 2A, 2B) of a consumer (4) connected to a change-over contact (3, 3A, 3B), the method comprising:
conducting a test using a test voltage to detect whether a consumer connected, wherein the test is conducted in a contactless time period during a connection of the relay (2, 2A, 2B)

16. A method according to claim 15, wherein during the connection of the relay (2, 2A, 2B), a test is conducted as to whether at least a part of the test voltage drops in the circuit of the consumer (4).

17. A method according to claim 16 further comprising: comparing a time behaviour of a voltage pulse is compared at a point in the circuit of the consumer (4) with definable comparative values in order to identify the drop in voltage.

18. A method according to any one of claims 15, wherein a negative test voltage is used.

19. A method according to claim 15, wherein the test voltage is generated from an operating voltage (U₀) of the relay (2, 2A, 2B) or of the consumer (4).

20. A device for detecting a consumer (4) connected to a change-over contact (3, 3A, 3B) of a relay (2, 2A, 2B), the device comprising:
a voltage source;
a resistance;
a consumer (4); and
a test device (8), wherein the test voltage, the resistance (6, 6A, 6B) and the consumer are connected in series and the test device (8) detects a voltage drop in the consumer (4) connected with the resistance (6, 6A, 6B).

21. A device according to claim 20, wherein the voltage source is designed as a capacitor (7, 7A, 7B).

22. A device according to claim 20, wherein the test device (8) is designed as a microcontroller.

23. A device according to claim 22, wherein the microcontroller (12) is connected via a comparator (10A, 10B) with the resistance (6A, 6B).

24. A device according to any one of claims 20, wherein test voltage conforms to an operating voltage (U₀) of the relay (2, 2A, 2B) or of the consumer (4).

25. A device according claim 20, wherein the relay (2A) is designed as a first relay of a relay bridge (2A, 2B).

26. A device according to claim 25, wherein the first relay (2A) is provided for a first polarity of the consumer (4), and a second relay (2B) of the relay bridge (2A, 2B) is provided for a second polarity of the consumer (4).

27. A device according to claim 26, wherein for the second relay (2B), a second voltage source is connected for a test voltage, and a second resistance (6B) is connected in series with the consumer (4).

28. A device according to claim 27, wherein the test device (8) for identifying a drop in voltage in the circuit of the consumer (4) is connected with the second resistance (6B).
